(19) United States
(12) Patent Application Publication
(10) Pub. No.: US 2026/0199063 A1
(43) Pub. Date: Jul. 16, 2026

(54) ORTHODONTIC APPLIANCE FOR CHILDREN'S DENTAL CROSSBITE AND A PREPARATION METHOD THEREOF

(71) Applicant: Baochen Zou, Baoding (CN)

(72) Inventor: Baochen Zou, Baoding (CN)

(21) Appl. No.: 19/326,127

(22) Filed: Sep. 11, 2025

(30) Foreign Application Priority Data
Jan. 14, 2025 (CN) 202510056017.7

(51) Int. Cl. A61C 7/20; A61C 7/28; A61C 7/36

(52) U.S. Cl. CPC A61C 7/20; A61C 7/282; A61C 7/36

(57) ABSTRACT

An orthodontic appliance for children's dental crossbite includes a nickel-titanium archwire for upper teeth, a steel archwire for lower teeth, two upper bands, two lower bands, two rubber bands, and a plurality of brackets; U-shaped springs are welded near both ends; two traction hooks are arranged on left and right of front part; the upper bands are sleeved on first permanent molars of upper teeth, and the traction hooks are located on an upper part of the buccal tubes; the lower bands are sleeved on first permanent molars of lower teeth; the brackets are bonded to crossbite teeth of upper teeth and four anterior teeth of the lower teeth; both the nickel-titanium archwire and the steel archwire are ligated in several brackets; both ends of the nickel-titanium archwire are threaded into the buccal tubes of the upper bands; two ends of the rubber bands hook and pull traction hooks.

### TECHNICAL FIELD

The invention relates to the technical field of orthodontic appliances for children's dental crossbite and a preparation method thereof, specifically referring to an orthodontic appliance for children's dental crossbite and a preparation method thereof.

### BACKGROUND ART

Dental crossbite, commonly known as "underbite" or "reverse bite," is a common type of dento-maxillofacial deformity. It has a significant impact on children's chewing function and the development of teeth and jaws. If the deformity is not treated in time after its occurrence, it will become more and more serious with age, leading to mandibular protrusion and midfacial depression, which greatly affects facial appearance. Nowadays, many parents use folk remedies such as biting chopsticks or bamboo skins to correct their children's dental crossbite when it occurs. Although individual children may be cured by chance, most children often get the opposite result. The deformity is not corrected, but some bad habits are formed, which also increases the difficulty of correction using scientific methods. According to the characteristics of children's physical development, for girls aged 6-8 and boys aged 7-9, when the upper incisors have just erupted (two or one) and dental crossbite initially appears, the children's jaws have just entered the peak period of development, which is the best time (golden period) for correction. If a suitable orthodontic appliance can be worn in time, the teeth can quickly correct the crossbite under the traction of the appliance. The timely correction of the crossbite relationship can quickly achieve the purpose of restricting the development of the mandible and promoting the development of the maxilla, so that dental crossbite will not develop into skeletal crossbite.

At present, there are three commonly used orthodontic appliances for early correction of crossbite: spring expander with bite plate, functional appliance and frontal traction appliance. These three appliances are highly targeted and need to distinguish between dental, skeletal and functional types before they can be worn. They all need to add bite plates to open the bite. Their common disadvantages are large volume, large force, too fast force attenuation, uneven force application, strong foreign body sensation and pain, which are difficult for children to tolerate. In addition, the manufacturing process is complex, installation is inconvenient, the wearing time is long, and the time to correct the crossbite is uncertain, ranging from about 3 to 6 months for a short time to 1 to 2 years for a long time. Moreover, the orthodontic effect cannot be guaranteed, and it is impossible to timely correct the dental crossbite at the best time when the incisors erupt.

### SUMMARY OF THE INVENTION

The purpose of the invention is to provide an orthodontic appliance for children's dental crossbite and a preparation method thereof to solve problems in background art. To achieve the above purpose, the invention provides the following technical solutions: an orthodontic appliance for children's dental crossbite includes a nickel-titanium archwire for upper teeth, a steel archwire for lower teeth, two upper bands, two lower bands, two rubber bands, and a plurality of brackets; the nickel-titanium archwire is U-shaped, U-shaped springs are welded near both ends; the steel archwire is U-shaped, with a first traction hook and a second traction hook arranged on left and right of a front part; the upper bands are provided with buccal tubes, and left and right buccal tubes are provided with a third traction hook and a fourth traction hook.

The upper bands are sleeved on first permanent molars of upper teeth, and the third traction hook and fourth traction hook are located on an upper part of the buccal tubes; the lower bands are sleeved on first permanent molars of lower teeth; the brackets are bonded to crossbite teeth of upper teeth and four anterior teeth of the lower teeth; both the nickel-titanium archwire and the steel archwire are ligated in several brackets; both ends of the nickel-titanium archwire are threaded into the buccal tubes of the upper bands; the opening of the U-shaped springs face downward; one end of the U-shaped springs close to the buccal tubes is a movable end, and one end of the U-shaped springs far from the buccal tubes is a welded end; both ends of the steel archwire are threaded into the buccal tubes of the lower bands; the first traction hook and second traction hook are close to corresponding lateral incisors and face upward; the left rubber band hooks and pulls the first traction hook and the third traction hook, and the right rubber band hooks and pulls the second traction hook and the fourth traction hook; the two rubber bands are pulled in an inverted V shape.

As an improvement, the diameter of the nickel-titanium archwire is 0.016, 0.018, or 0.020 inches, and the diameter of the steel archwire is 0.016 inches.

As an improvement, the width of both the nickel-titanium archwire and the steel archwire is 3-6 cm.

As an improvement, a movable end of the U-shaped spring is provided with a loop, and the nickel-titanium archwire passes through the loop.

As an improvement, the U-shaped spring has a diameter of 0.5 mm, a height of 0.5 cm, and a width of 0.6 cm; the material of the U-shaped spring is steel wire.

The tension of the rubber band is 140-150g.

A method for preparing an orthodontic appliance for children's dental crossbite includes the following steps:

step 1: make a dental model of the child with crossbite to be corrected; sleeve two upper bands on two first permanent molars of the upper teeth of the dental model, and sleeve two lower bands on the two first permanent molars of the lower teeth of the dental model; the buccal tubes of two bands are all facing outward, and the third traction hook and fourth traction hook of the left and right upper bands are all on the upper part of the buccal tubes;

step 2: select a nickel-titanium wire, make a matching U-shaped nickel-titanium archwire according to the width of an upper dental arch of the dental model, insert both ends of the nickel-titanium archwire into the buccal tubes, make a front end of the nickel-titanium archwire arch out of the dental arch, and then cut off the nickel-titanium archwire from a rear end of the buccal tubes;

step 3: weld U-shaped springs near the buccal tubes of the nickel-titanium archwire, with the opening of the U-shaped springs face downward; one end of the U-shaped springs close to the buccal tubes is a movable end, and one end of the U-shaped springs far from the buccal tubes is a welded end;

step 4: select a steel wire, make a matching U-shaped steel archwire according to the width of a lower dental arch of the dental model, insert both ends of the steel archwire into the buccal tubes, make a front end of the steel archwire stick to the teeth, and then cut off the steel archwire from the rear end of the buccal tubes;

step 5: weld upward the first traction hook and the second traction hook near left and right lateral incisors of the steel archwire;

step 6: sleeve two upper bands on the two first permanent molars of the child's upper teeth, and sleeve the two lower bands on the two first permanent molars of the child's lower teeth; the buccal tubes of the two bands are all facing outward, and the third traction hook and fourth traction hook of the left and right upper bands are all on the upper part of the buccal tubes;

step 7: bond brackets to the crossbite teeth of the upper teeth and the four anterior teeth of the lower teeth;

step 8: insert the welded nickel-titanium archwire into the buccal tubes of the upper teeth, squeeze the front end of the nickel-titanium archwire inward to stick to the teeth with a push-pull dynamometer, measure the resilience of the nickel-titanium archwire, which is required to be 160-190g; if it is not satisfied, fine-tune by moving the movable end of the U-shaped springs to change the distance between the front end of the nickel-titanium archwire and the teeth until the measured resilience meets the requirement; if it cannot be met, it will be discarded and remade;

step 9: squeeze the front end of the nickel-titanium archwire inward and ligate it in the brackets of the crossbite teeth;

step 10: insert both ends of the steel archwire into the buccal tubes of the lower teeth and ligate them in the brackets on the four lower anterior teeth, with the first traction hook and second traction hook facing upward;

step 11: select two rubber bands; the left rubber band hooks and pulls the first traction hook and the third traction hook, and the right rubber band hooks and pulls the second traction hook and the fourth traction hook; the two rubber bands are pulled in an inverted V shape.

As an improvement, the front end of the nickel-titanium archwire in step 2 arches out of the dental arch by 1-1.2 cm.

As an improvement, the resilience required in step 8 is 180g.

The advantages of the invention compared with the prior art are as follows: the orthodontic appliance for children's dental crossbite does not need to distinguish between dental, skeletal, and functional crossbite, and is applicable to the early treatment of all children's dental crossbite. It does not require adding an occlusal pad to open the bite; instead, it utilizes the interocclusal space to correct the dental crossbite. It is equivalent to setting up a small frame for children's teeth at the optimal time. By using the resilience, memory, and sustained-release properties of the nickel-titanium archwire and rubber bands, the teeth are pulled out to correct the crossbite. The manufacturing process is simple, it is convenient to install, and it is easy to retain, so there is no situation where it cannot be installed. By pulling the teeth externally, it is easy to apply force, and the resilience generated by the nickel-titanium archwire is soft and long-lasting, with almost no obvious pain or foreign body sensation. Therefore, the time to correct the crossbite is short, and the child's pain is minimal. The orthodontic quality is good, and it is not easy to rebound.

### BRIEF DESCRIPTION OF ACCOMPANY DRAWINGS

To more clearly illustrate the embodiments of the invention or the technical solutions in the prior art, a brief introduction to the drawings needed in the description of the embodiments or the prior art will be given below. Obviously, the drawings listed below are only some structural diagrams of the invention, not all of them.

FIG. 1 is a first structural diagram of an orthodontic appliance for children's dental crossbite according to the invention.

FIG. 2 is a second structural diagram of an orthodontic appliance for children's dental crossbite according to the invention.

FIG. 3 is a third structural diagram of an orthodontic appliance for children's dental crossbite according to the invention.

FIG. 4 is a structural diagram of the nickel-titanium archwire of the orthodontic appliance for children's dental crossbite according to the invention.

FIG. 5 is a side view of the nickel-titanium archwire of the orthodontic appliance for children's dental crossbite according to the invention.

FIG. 6 is a structural diagram of the steel archwire of the orthodontic appliance for children's dental crossbite according to the invention.

FIG. 7 is a side view of the steel archwire of the orthodontic appliance for children's dental crossbite according to the invention.

FIG. 8 is a structural diagram of the band of the orthodontic appliance for children's dental crossbite according to the invention.

In the drawings: 1 nickel-titanium archwire; 2 bracket; 3 first traction hook; 4 rubber band; 5 upper band; 6 steel archwire; 7 lower band; 8 buccal tube; 9 U-shaped spring; 10 loop; 11 second traction hook; 12 third traction hook; 13 fourth traction hook.

### SPECIFIC EMBODIMENT OF THE INVENTION

The technical solutions in the embodiments of the invention will be clearly and completely described below in conjunction with the drawings in the embodiments of the invention. Obviously, the described embodiments are only part of the embodiments of the invention, not all of them. Based on the embodiments of the invention, all other embodiments obtained by those of ordinary skill in the art without creative work shall fall within the protection scope of the invention.

In the description of the embodiments of the invention, it should be noted that if the terms "center", "upper", "lower", "left", "right", "vertical", "horizontal", "inner", "outer" and the like appear, the indicated orientation or positional relationship is based on the orientation or positional relationship shown in the drawings, or the orientation or positional relationship commonly placed when the product of the invention is used, which is only for the convenience of describing the invention and simplifying the description, rather than indicating or implying that the device or element referred to must have a specific orientation, be constructed and operated in a specific orientation, and therefore cannot be understood as a limitation to the invention.

In addition, if the terms "first", "second", "third" and the like appear, they are only used for distinguishing descriptions, and cannot be understood as indicating or implying relative importance. If the terms "horizontal", "vertical", "overhanging" and the like appear, they do not mean that the component is required to be absolutely horizontal or overhanging, but can be slightly inclined. For example, "horizontal" only means that its direction is more horizontal than "vertical", not that the structure must be completely horizontal, but can be slightly inclined.

In the description of the embodiments of the invention, if the terms "plurality" and "several" appear, they mean at least two.

In the description of the embodiments of the invention, it should also be noted that unless otherwise clearly specified and limited, if the terms "arrangement", "installation", "connection" and "link" appear, they should be understood in a broad sense. For example, it can be a fixed connection, a detachable connection, or an integral connection; it can be a mechanical connection or an electrical connection; it can be a direct connection or an indirect connection through an intermediate medium, or it can be the internal communication between two elements. For those of ordinary skill in the art, the specific meanings of the above terms in the invention can be understood according to specific situations.

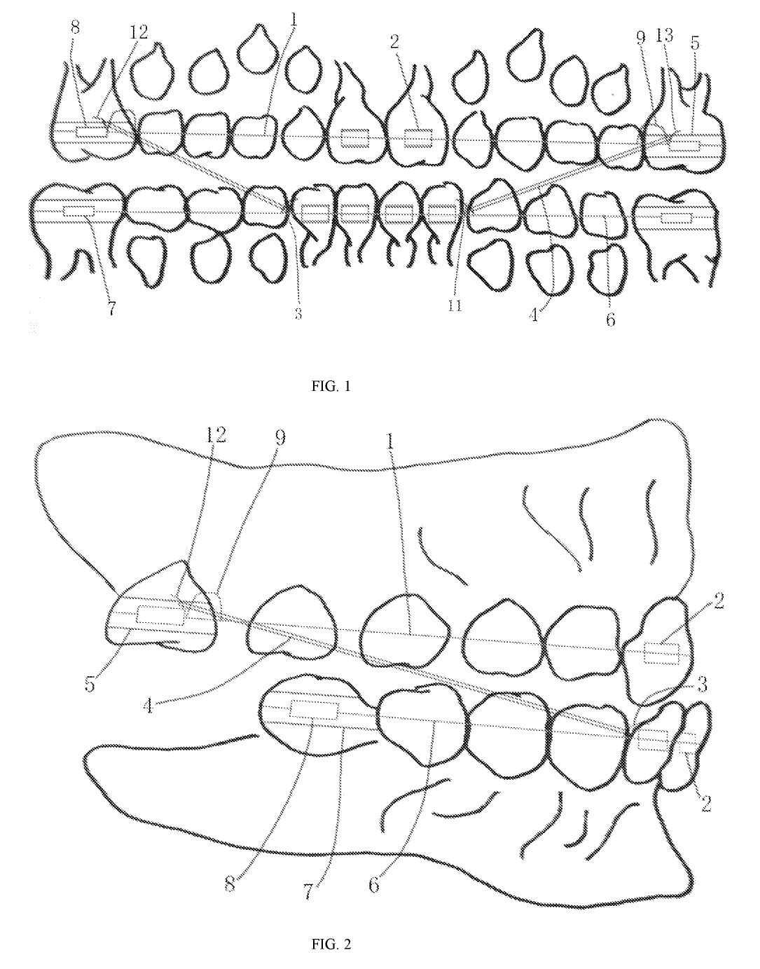

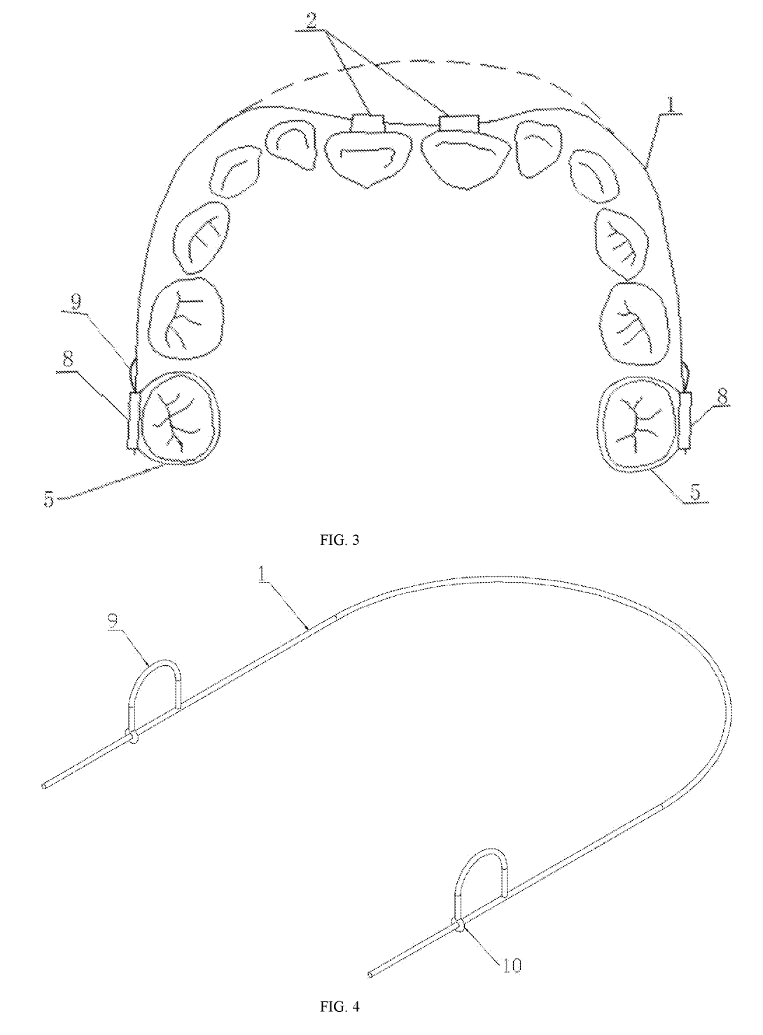

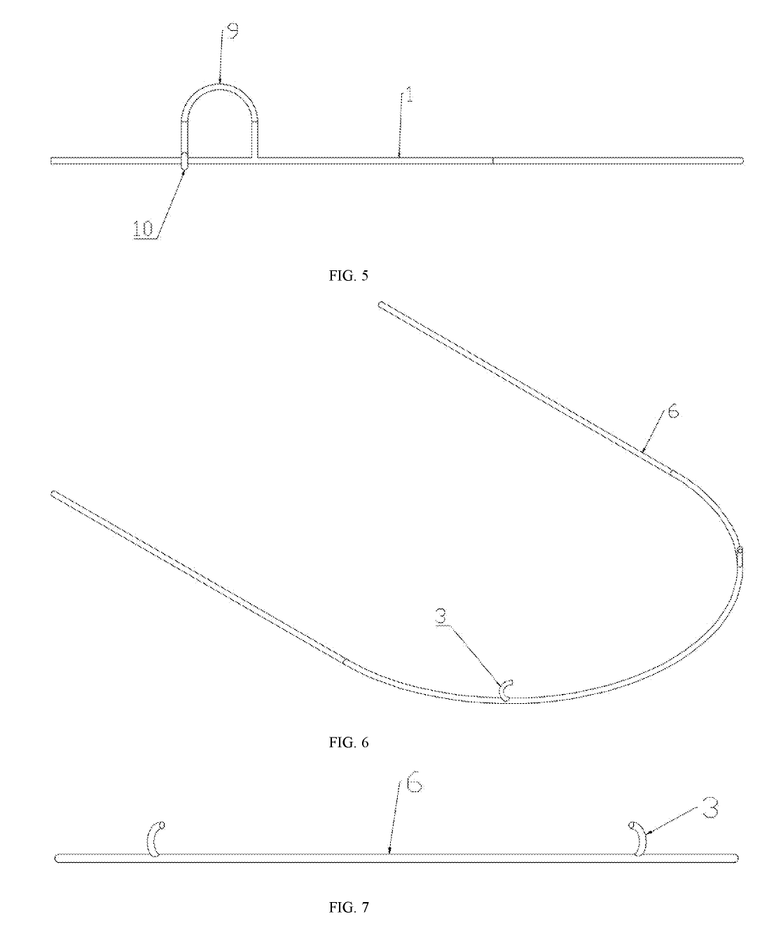

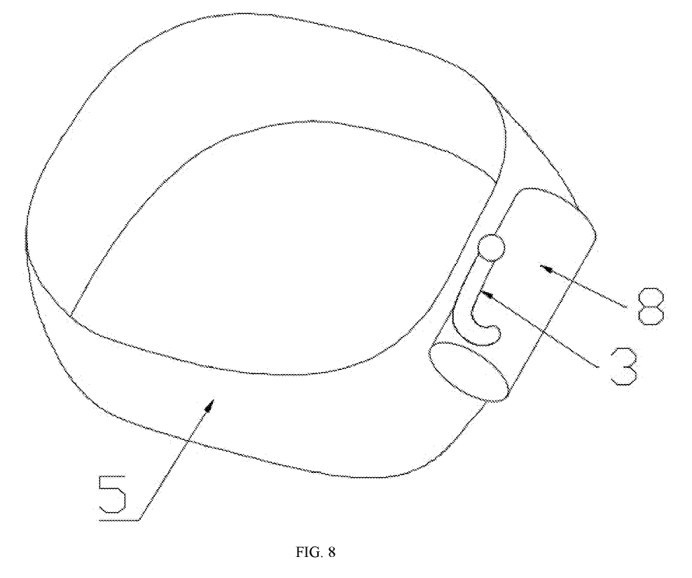

The embodiment will describe in detail an orthodontic appliance for children's dental crossbite and a preparation method thereof in conjunction with FIG. 1 to FIG. 8.

An orthodontic appliance for children's dental crossbite in this embodiment includes a nickel-titanium archwire 1 for upper teeth, a steel archwire 6 for lower teeth, two upper bands 5, two lower bands 7, two rubber bands 4, and a plurality of brackets 2.

The nickel-titanium archwire 1 is U-shaped, which is a commonly used U-shaped nickel-titanium archwire in the field; U-shaped springs 9 are welded near both ends; the U-shaped springs 9 are used to adjust the arch degree of the nickel-titanium archwire 1; the steel archwire 6 is U-shaped, with a first traction hook 3 and a second traction hook 11 arranged on left and right of a front part for hooking and pulling the rubber bands 4; the upper bands 5 (which are commonly used bands with traction hooks in the field) are provided with buccal tubes 8, and left and right buccal tubes 8 are provided with a third traction hook 12 and a fourth traction hook 13; the buccal tubes 8 of the lower bands 7 (which are commonly used bands without traction hooks in the field) do not need to have traction hooks.

The upper bands 5 are sleeved on first permanent molars of upper teeth, and the third traction hook 12 and fourth traction hook 13 are located on an upper part of the buccal tubes 8; the lower bands 7 are sleeved on first permanent molars of lower teeth; the brackets 2 are bonded to crossbite teeth of upper teeth and four anterior teeth of the lower teeth; both the nickel-titanium archwire 1 and the steel archwire 6 are ligated (in a conventional connection method in the field) in several brackets 2; both ends of the nickel-titanium archwire 1 are threaded into the buccal tubes 8 of the upper bands 5; the opening of the U-shaped springs 9 face downward, with main body attached to an upper tooth surface without conflicting with the lower teeth; one end of the U-shaped springs 9 close to the buccal tubes 8 is a movable end, and one end of the U-shaped springs 9 far from the buccal tubes 8 is a welded end. Moving a movable end changes the width of the U-shaped springs 9, thereby changing the arch degree of the nickel-titanium archwire 1. Both ends of the steel archwire 6 are threaded into the buccal tubes 8 of the lower bands 7; the first traction hook 3 and second traction hook 11 are close to corresponding lateral incisors and face upward;

the left rubber band 4 hooks and pulls the first traction hook 3 and the third traction hook 12, and the right rubber band 4 hooks and pulls the second traction hook 11 and the fourth traction hook 13; the two rubber bands 4 are pulled in an inverted V shape (forming an inward pulling traction on four lower anterior teeth).

The diameter of the nickel-titanium archwire 1 is 0.016, 0.018, or 0.020 inches, and the resilience is within an appropriate range; the diameter of the steel archwire 6 is 0.016 inches, and the elasticity is within an appropriate range.

The width of both the nickel-titanium archwire 1 and the steel archwire 6 is 3-6 cm, which is suitable for children in the mixed dentition stage.

A movable end of the U-shaped spring 9 is provided with a loop 10, and the nickel-titanium archwire 1 passes through the loop 10.

The U-shaped spring 9 has a diameter of 0.5 mm, a height of 0.5 cm, and a width of 0.6 cm. The material of the U-shaped spring 9 is steel wire, and its size and material meet the requirement of appropriate elasticity.

The tension of the rubber band 4 is 140-150g, which meets the requirement of appropriate elasticity.

A method for preparing an orthodontic appliance for children's dental crossbite includes the following steps:

step 1: make a dental model of the child with crossbite to be corrected; sleeve two upper bands 5 on two first permanent molars of the upper teeth of the dental model, and sleeve two lower bands 7 on the two first permanent molars of the lower teeth of the dental model; the buccal tubes 8 of two bands are all facing outward, and the third traction hook 12 and fourth traction hook 13 of the left and right upper bands 5 are all on the upper part of the buccal tubes 8;

step 2: select a nickel-titanium wire, make a matching U-shaped nickel-titanium archwire 1 according to the width of an upper dental arch of the dental model, insert both ends of the nickel-titanium archwire 1 into the buccal tubes 8, make a front end of the nickel-titanium archwire 1 arch out of the dental arch, and then cut off the nickel-titanium archwire 1 from a rear end of the buccal tubes 8;

step 3: weld U-shaped springs 9 near the buccal tubes 8 of the nickel-titanium archwire 1, with the opening of the U-shaped springs 9 face downward; one end of the U-shaped springs 9 close to the buccal tubes 8 is a movable end, and one end of the U-shaped springs 9 far from the buccal tubes 8 is a welded end;

step 4: select a steel wire, make a matching U-shaped steel archwire 6 according to the width of a lower dental arch of the dental model, insert both ends of the steel archwire 6 into the buccal tubes 8, make a front end of the steel archwire 6 stick to the teeth, and then cut off the steel archwire 6 from the rear end of the buccal tubes 8;

step 5: weld upward the first traction hook 3 and the second traction hook 11 near left and right lateral incisors of the steel archwire 6;

step 6: sleeve two upper bands 5 on the two first permanent molars of the child's upper teeth, and sleeve the two lower bands 7 on the two first permanent molars of the child's lower teeth; the buccal tubes 8 of the two bands are all facing outward, and the third traction hook 12 and fourth traction hook 13 of the left and right upper bands 5 are all on the upper part of the buccal tubes 8;

step 7: bond brackets 2 to the crossbite teeth of the upper teeth and the four anterior teeth of the lower teeth;

step 8: insert the welded nickel-titanium archwire 1 into the buccal tubes 8 of the upper teeth, squeeze the front end of the nickel-titanium archwire 1 inward to stick to the teeth with a push-pull dynamometer, measure the resilience of the nickel-titanium archwire 1, which is required to be 160-190g; if it is not satisfied, fine-tune by moving the movable end of the U-shaped springs 9 to change the distance between the front end of the nickel-titanium archwire 1 and the teeth until the measured resilience meets the requirement; if it cannot be met, it will be discarded and remade;

step 9: squeeze the front end of the nickel-titanium archwire 1 inward and ligate it in the brackets 2 of the crossbite teeth to form an outward pulling force on the crossbite teeth;

step 10: insert both ends of the steel archwire 6 into the buccal tubes 8 of the lower teeth and ligate them in the brackets 2 on the four lower anterior teeth, with the first traction hook 3 and second traction hook 11 facing upward;

step 11: select two rubber bands 4; the left rubber band 4 hooks and pulls the first traction hook 3 and the third traction hook 12, and the right rubber band 4 hooks and pulls the second traction hook 11 and the fourth traction hook 13; the two rubber bands 4 are pulled in an inverted V shape to form an inward pulling traction on the four lower anterior teeth.

As an improvement, the front end of the nickel-titanium archwire 1 in step 2 arches out of the dental arch by 1-1.2 cm.

As an improvement, the resilience required in step 8 is 180g.

In specific implementation, the nickel-titanium archwire is a nickel-titanium alloy archwire, and the steel archwire 6 is an orthodontic stainless steel wire, and Australian-style imitation wire can also be used. When making and using the orthodontic appliance according to the above steps, it is recommended to wear it after dinner. The child can be told to eat one hour in advance, and no food is allowed after wearing it at night to prevent the brackets 2 from falling off during chewing. If root apex of the child's incisors is not fully developed, the resilience of the nickel-titanium archwire 1 is required to be 160-170g. If the child's first permanent molars of the upper teeth have not erupted, the bands can be installed on fifth deciduous teeth, and there is no situation where they cannot be installed.

This orthodontic appliance does not need to add an occlusal pad to open the bite, but uses the interocclusal space to correct the dental crossbite. Usually, the dental crossbite can be corrected overnight. After maintaining for one to two weeks, take the dental model again according to the above steps, make appropriate nickel-titanium archwires and steel archwires, wear them together with bands and brackets, stop the rubber band traction, and follow up the treatment until the upper anterior teeth 21 | 12 erupt, until the four upper anterior teeth and lower anterior teeth reach a normal overbite and overjet relationship, and posterior molars (first permanent molars) are adjusted to a neutral occlusal relationship, and maintain for 1 to 3 months (depending on the situation), then remove the archwires.

The above describes the invention and its embodiments, which is not restrictive. The actual protection scope is not limited thereto. Any changes or substitutions easily thought of by those skilled in the art within the technical scope disclosed by the invention shall be covered by the protection scope of the invention. Therefore, the protection scope of the invention shall be subject to the protection scope of the claims.

1. An orthodontic appliance for children's dental crossbite, including a nickel-titanium archwire for upper teeth, a steel archwire for lower teeth, two upper bands, two lower bands, two rubber bands, and a plurality of brackets;
the nickel-titanium archwire is U-shaped, U-shaped springs are welded near both ends; the steel archwire is U-shaped, with a first traction hook and a second traction hook arranged on left and right of a front part; the upper bands are provided with buccal tubes, and left and right buccal tubes are provided with a third traction hook and a fourth traction hook;
the upper bands are sleeved on first permanent molars of upper teeth, and the third traction hook and fourth traction hook are located on an upper part of the buccal tubes; the lower bands are sleeved on first permanent molars of lower teeth; the brackets are bonded to crossbite teeth of upper teeth and four anterior teeth of the lower teeth; both the nickel-titanium archwire and the steel archwire are ligated in several brackets; both ends of the nickel-titanium archwire are threaded into the buccal tubes of the upper bands; the opening of the U-shaped springs face downward; one end of the U-shaped springs close to the buccal tubes is a movable end, and one end of the U-shaped springs far from the buccal tubes is a welded end; both ends of the steel archwire are threaded into the buccal tubes of the lower bands; the first traction hook and second traction hook are close to corresponding lateral incisors and face upward;
the left rubber band hooks and pulls the first traction hook and the third traction hook, and the right rubber band hooks and pulls the second traction hook and the fourth traction hook; the two rubber bands are pulled in an inverted V shape.

2. The orthodontic appliance for children's dental crossbite according to claim 1, wherein the diameter of the nickel-titanium archwire is 0.016, 0.018, or 0.020 inches, and the diameter of the steel archwire is 0.016 inches.

3. The orthodontic appliance for children's dental crossbite according to claim 1, wherein the width of both the nickel-titanium archwire and the steel archwire is 3-6 cm.

4. The orthodontic appliance for children's dental crossbite according to claim 1, wherein a movable end of the U-shaped spring is provided with a loop, and the nickel-titanium archwire passes through the loop.

5. The orthodontic appliance for children's dental crossbite according to claim 1, wherein the U-shaped spring has a diameter of 0.5 mm, a height of 0.5 cm, and a width of 0.6 cm; the material of the U-shaped spring is steel wire.

6. The orthodontic appliance for children's dental crossbite according to claim 1, wherein the tension of the rubber band is 140-150g.

7. A method for preparing an orthodontic appliance for children's dental crossbite according to claim 1, including the following steps:
step 1: make a dental model of the child with crossbite to be corrected; sleeve two upper bands on two first permanent molars of the upper teeth of the dental model, and sleeve two lower bands on the two first permanent molars of the lower teeth of the dental model; the buccal tubes of two bands are all facing outward, and the third traction hook and fourth traction hook of the left and right upper bands are all on the upper part of the buccal tubes;
step 2: select a nickel-titanium wire, make a matching U-shaped nickel-titanium archwire according to the width of an upper dental arch of the dental model, insert both ends of the nickel-titanium archwire into the buccal tubes, make a front end of the nickel-titanium archwire arch out of the dental arch, and then cut off the nickel-titanium archwire from a rear end of the buccal tubes;
step 3: weld U-shaped springs near the buccal tubes of the nickel-titanium archwire, with the opening of the U-shaped springs face downward; one end of the U-shaped springs close to the buccal tubes is a movable end, and one end of the U-shaped springs far from the buccal tubes is a welded end;
step 4: select a steel wire, make a matching U-shaped steel archwire according to the width of a lower dental arch of the dental model, insert both ends of the steel archwire into the buccal tubes, make a front end of the steel archwire stick to the teeth, and then cut off the steel archwire from the rear end of the buccal tubes;
step 5: weld upward the first traction hook and the second traction hook near left and right lateral incisors of the steel archwire;
step6: sleeve two upper bands on the two first permanent molars of the child's upper teeth, and sleeve the two lower bands on the two first permanent molars of the child's lower teeth; the buccal tubes of the two bands are all facing outward, and the third traction hook and fourth traction hook of the left and right upper bands are all on the upper part of the buccal tubes;
step 7: bond brackets to the crossbite teeth of the upper teeth and the four anterior teeth of the lower teeth;
step8: insert the welded nickel-titanium archwire into the buccal tubes of the upper teeth, squeeze the front end of the nickel-titanium archwire inward to stick to the teeth with a push-pull dynamometer, measure the resilience of the nickel-titanium archwire, which is required to be 160-190g; if it is not satisfied, fine-tune by moving the movable end of the U-shaped springs to change the distance between the front end of the nickel-titanium archwire and the teeth until the measured resilience meets the requirement; if it cannot be met, it will be discarded and remade;
step 9: squeeze the front end of the nickel-titanium archwire inward and ligate it in the brackets of the crossbite teeth;
step10: insert both ends of the steel archwire into the buccal tubes of the lower teeth and ligate them in the brackets on the four lower anterior teeth, with the first traction hook and second traction hook facing upward;
step 11: select two rubber bands; the left rubber band hooks and pulls the first traction hook and the third traction hook, and the right rubber band hooks and pulls the second traction hook and the fourth traction hook; the two rubber bands are pulled in an inverted V shape.

8. The method for preparing an orthodontic appliance for children's dental crossbite according to claim 7, wherein the front end of the nickel-titanium archwire in step 2 arches out of the dental arch by 1-1.2 cm.

9. The method for preparing an orthodontic appliance for children's dental crossbite according to claim 7, wherein the resilience required in step 8 is 180g.
